(19) United States
(12) Patent Application Publication
(10) Pub. No.: US 2010/0136236 A1
(43) Pub. Date: Jun. 3, 2010

(54) Ink set and printing method

(75) Inventors: Tetsuo Hosoya, Amimachi (JP); Sayako Arai, Amimachi (JP); Shunsuke Uozumi, Amimachi (JP); Yoshifumi Watanabe, Amimachi (JP); Shin-ichiro Shimura, Amimachi (JP); Marie Morinaga, Amimachi (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/591,207

(22) Filed: Nov. 12, 2009

(30) Foreign Application Priority Data
Dec. 2, 2008 (JP) P2008-307521

(51) Int. Cl. B05D 1/36; C08L 75/04

(52) U.S. Cl. 427/261; 524/589

(57) ABSTRACT

Disclosed is an ink set, comprising:
a non-aqueous pigment ink comprising a pigment, a non-aqueous solvent, and a non-aqueous resin dispersion microparticle having a pigment dispersion capability, wherein
the non-aqueous resin dispersion microparticle is a graft copolymer prepared by introducing urethane groups into a copolymer formed from a monomer mixture comprising an alkyl(meth)acrylate (A) having an alkyl group of 12 or more carbon atoms, a reactive (meth)acrylate (B) having a functional group capable of reacting with an amino group, and a (meth)acrylate (C) having a β-diketone group or β-keto ester group by reacting the functional group capable of reacting with an amino group with an amino alcohol and a polyvalent isocyanate compound, and
a treatment liquid comprising a compound capable of reacting with the β-diketone group or β-keto ester group.

### CROSS REFERENCE TO RELATED APPLICATIONS

This Application is based upon and claims the benefit of priority from prior Japanese Patent Application No. 2008-307521 filed on Dec. 2, 2008; the entire contents of which are incorporated by reference herein.

### BACKGROUND OF THE INVENTION

1. Field of the Invention

The present invention relates to an ink set comprising a non-aqueous pigment ink and a treatment liquid, and a printing method that uses this ink set.

2. Description of the Related Art

The coloring materials for the inks used in inkjet recording systems can be broadly classified into materials that use pigments and materials that use dyes. Of these, there is a growing tendency for the use of inks that use pigments as the coloring materials, as such inks exhibit the excellent levels of light resistance, weather resistance and water resistance that are required for high image quality printing.

In terms of the solvent, inks can be broadly classified into aqueous inks and non-aqueous inks. Non-aqueous inks that do not use water as the ink solvent, including solvent-based inks that use a volatile solvent as the main constituent and oil-based inks that use a non-volatile solvent as the main constituent, exhibit superior drying properties to aqueous inks, and also exhibit excellent printability.

In non-aqueous inks, a pigment dispersant that dissolves in the solvent is generally used, but because this pigment dispersant improves the affinity between the solvent and the pigment, when the solvent penetrates into the recording paper, the pigment tends to be also drawn into the interior of the recording paper. As a result, the print density tends to fall, and show-through becomes more prevalent.

Accordingly, a non-aqueous pigment ink has been proposed that uses non-aqueous resin dispersion microparticles (NAD=Non Aqua Dispersion) having a pigment dispersion capability as a dispersant (see Japanese Patent Laid-Open No. 2007-197500).

By using a pigment dispersant that does not dissolve in the solvent, this non-aqueous ink is able to provide improved print density for printed items on plain paper, but further improvements are still required in terms of suppressing show-through on the printed item and further improving the print density.

### SUMMARY OF THE INVENTION

One aspect of the present invention provides an ink set, comprising:

a non-aqueous pigment ink comprising a pigment, a non-aqueous solvent, and a non-aqueous resin dispersion microparticle having a pigment dispersion capability, wherein

the non-aqueous resin dispersion microparticle is a graft copolymer prepared by introducing urethane groups into a copolymer formed from a monomer mixture comprising an alkyl(meth)acrylate (A) having an alkyl group of 12 or more carbon atoms, a reactive (meth)acrylate (B) having a functional group capable of reacting with an amino group, and a (meth)acrylate (C) having a β-diketone group or β-keto ester group by reacting the functional group capable of reacting with an amino group with an amino alcohol and a polyvalent isocyanate compound, and

a treatment liquid comprising a compound capable of reacting with the β-diketone group or β-keto ester group.

Another aspect of the present invention provides a printing method, comprising:

adhering a treatment liquid comprising a compound capable of reacting with a β-diketone group or β-keto ester group to a recording medium, and

forming an image on the recording medium using a non-aqueous pigment ink comprising a pigment, a non-aqueous solvent, and a non-aqueous resin dispersion microparticle having a pigment dispersion capability, wherein

the non-aqueous resin dispersion microparticle is a graft copolymer prepared by introducing urethane groups into a copolymer formed from a monomer mixture comprising an alkyl(meth)acrylate (A) having an alkyl group of 12 or more carbon atoms, a reactive (meth)acrylate (B) having a functional group capable of reacting with an amino group, and a (meth)acrylate (C) having a β-diketone group or β-keto ester group by reacting the functional group capable of reacting with an amino group with an amino alcohol and a polyvalent isocyanate compound.

### DETAILED DESCRIPTION OF THE EMBODIMENTS

An ink set according to the present invention is composed of a non-aqueous ink (hereafter also referred to as simply “the ink”) comprising a non-aqueous resin dispersion microparticle of a specific graft copolymer as a pigment dispersant, and a treatment liquid that reacts with the graft polymer. The action of the treatment liquid causes aggregation of the ink droplets, meaning penetration of the ink into the recording medium can be suppressed. As a result, the present invention is able to realize an improvement in the surface density of a printed item, and a suppression of show-through.

The ink used in the ink set comprises, as essential components, a pigment, a non-aqueous solvent (hereafter also referred to as simply “the solvent”), and a non-aqueous resin dispersion microparticle (NAD=Non Aqua Dispersion, hereafter also referred to as “NAD microparticles” or “NAD particles”) having a pigment dispersion capability as a pigment dispersant.

The NAD microparticles are formed from an acrylic polymer (urethane-modified acrylic polymer) that is a graft copolymer comprising alkyl(meth)acrylate units having an alkyl group of 12 or more carbon atoms, (meth)acrylate units having a β-diketone group or β-keto ester group, and (meth)acrylate units having a urethane group, and this acrylic polymer does not dissolve in the non-aqueous solvent used in the ink, but rather forms microparticles within the ink. Here, the term “(meth)acrylate” is a generic term that includes both acrylate and methacrylate.

The NAD microparticles undergo a strong interaction (adsorption) with the pigment, and therefore image show-through on the printed item can be reduced, the storage stability of the ink can be improved, and favorable storage stability can be achieved not only under normal usage conditions, but also in high-temperature environments. Moreover, because even a small amount of the non-aqueous resin dispersion microparticles is capable of generating a satisfactory pigment dispersion effect, the blend amount may be less than that of conventional pigment dispersants, meaning the viscosity of the ink can be suppressed to a low level, thereby enabling the discharge stability to be improved when the ink is used as an inkjet ink.

More specifically, the NAD microparticles form a core/shell structure composed of a core portion (a polar portion) that does not dissolve in the non-aqueous solvent of the ink, and a shell portion (a low-polarity portion) that is positioned at the solvent side of each microparticle and is solvated. It is thought that the core portion that is insoluble in the solvent has a role of improving the separation of the pigment and the solvent following printing, thereby preventing the pigment from penetrating into the interior of the paper together with the solvent, which enables the pigment to be retained at the paper surface, thus improving the print density. In contrast, it is thought that the shell portion (steric repulsion layer) has a role of enhancing the dispersion stability within the solvent, thereby forming the particle dispersion system.

Moreover, the β-diketone groups or β-keto ester groups of these NAD microparticles undergo reaction with a compound in the treatment liquid, which is thought to cause an aggregation of the ink droplets that further enhances the retention of the pigment at the paper surface.

The above NAD microparticles can be favorably produced by preparing a copolymer formed from a monomer mixture comprising an alkyl(meth)acrylate (A) having an alkyl group of 12 or more carbon atoms (hereafter also referred to as “the monomer (A)”), a reactive (meth)acrylate (B) having a functional group capable of reacting with an amino group (hereafter also referred to as “the monomer (B)”), and a (meth)acrylate (C) having a β-diketone group or β-keto ester group (hereafter also referred to as “the monomer (C)”) (hereafter, this copolymer may also be referred to as “the backbone polymer”), and subsequently conducting a grafting process to introduce urethane groups into the copolymer by reacting the above functional group capable of reacting with an amino group with an amino alcohol and a polyvalent isocyanate compound.

Due to the inclusion of a long-chain alkyl group of 12 or more carbon atoms, the aforementioned alkyl(meth)acrylate units exhibit excellent affinity with the non-aqueous solvent, thereby enhancing the dispersion stability within the non-aqueous solvent and performing the role of the shell portion. The alkyl chain of the ester portion may be either a linear or branched chain. Although there are no particular restrictions on the upper limit for the number of carbon atoms within this alkyl group, for reasons including availability of the raw material, the number of carbon atoms is preferably not more than 25.

Examples of the alkyl group of 12 or more carbon atoms include a dodecyl group, tridecyl group, tetradecyl group, pentadecyl group, hexadecyl group, heptadecyl group, octadecyl group, nonadecyl group, eicosanyl group, heneicosanyl group, docosanyl group, isododecyl group or isooctadecyl group. A plurality of these groups may also be included.

Specific examples of the alkyl(meth)acrylate (A) having a long-chain alkyl group of 12 or more carbon atoms, and preferably 12 to 25 carbon atoms, include lauryl (meth)acrylate, cetyl(meth)acrylate, stearyl(meth)acrylate, behenyl(meth)acrylate, isolauryl(meth)acrylate and isostearyl(meth)acrylate. A plurality of these (meth)acrylates may also be included.

Preferred examples of the functional group capable of reacting with an amino group in the reactive (meth)acrylate (B) include a glycidyl group, vinyl group and (meth)acryloyl group.

An example of the monomer (B) containing a glycidyl group is glycidyl (meth)acrylate, whereas examples of the monomer (B) containing a vinyl group include vinyl(meth)acrylate and 2-(2-vinyloxyethoxy)ethyl(meth)acrylate. Examples of the monomer (B) containing a (meth)acryloyl group include dipropylene glycol di(meth)acrylate and 1,6-hexanediol di(meth)acrylate. A plurality of these reactive (meth)acrylates (B) may also be included.

In the (meth)acrylate (C) having a β-diketone group or β-keto ester group, preferred examples of the β-diketone group include an acetoacetyl group (CH₃—CO—CH₂—CO—) and a propionacetyl group (CH₃CH₂—CO—CH₂—CO—), whereas preferred examples of the β-keto ester group include an acetoacetoxy group (CH₃—CO—CH₂—COO—) and a propionacetoxy group (CH₃CH₂—CO—CH₂—COO—), although these are not exhaustive lists.

Specific examples of the monomer (C) include acetoacetoxyalkyl(meth)acrylates such as acetoacetoxyethyl(meth)acrylate, hexadione (meth)acrylate, and acetoacetoxyalkyl(meth)acrylamides such as acetoacetoxyethyl(meth)acrylamide. These monomers may be used individually, or in combinations of two or more compounds.

The monomer mixture may also include, besides the monomers (A), (B) and (C) described above, a monomer (D) that is copolymerizable with these monomers, provided inclusion of the monomer (D) does not impair the effects of the present invention. This monomer (D) may be used as required for purposes such as regulating the glass transition temperature or solubility of the product polymer, or preventing crystallization of the polymer.

Specific examples of the monomer (D) include styrene-based monomers such as styrene and α-methylstyrene, vinyl acetate, vinyl benzoate, vinyl ether-based monomers such as butyl vinyl ether, maleate esters, fumarate esters, acrylonitrile, methacrylonitrile and α-olefins. Further, alkyl(meth)acrylates in which the alkyl chain length is less than 12 carbon atoms may also be used, including 2-ethylhexyl(meth)acrylate, isooctyl (meth)acrylate and tert-octyl(meth)acrylate. These monomers may be used individually, or in combinations of two or more compounds.

The amount of the monomer (A) in the above monomer mixture is preferably not less than 30% by mass, is more preferably within a range from 40 to 95% by mass, and is most preferably from 50 to 90% by mass.

The monomer (B) exhibits reactivity, and functions as the active site for introducing the urethane group that functions as a pigment adsorption group. If the amount of introduced urethane groups is too low, then the pigment dispersibility is unsatisfactory. In contrast, if the amount of introduced urethane groups is too high, the viscosity of the ink tends to become overly high, making it difficult to ensure satisfactory discharge stability for the ink. For these reasons, the amount of the monomer (B) within the monomer mixture is preferably within a range from 1 to 30% by mass, and is more preferably from 3 to 25% by mass.

Considering the effects obtained by adding the monomer (C) and the storage stability of the resulting ink, the amount of the monomer (C) is preferably within a range from 3 to 30% by mass, and is more preferably from 5 to 20% by mass.

The monomers described above can be polymerized easily by conventional radical copolymerization. The reaction is preferably conducted as either a solution polymerization or a dispersion polymerization.

In order to ensure that the molecular weight of the copolymer following polymerization falls within a preferred range, the use of a chain transfer agent during polymerization is effective. Examples of compounds that can be used as this chain transfer agent include thiols such as n-butyl mercaptan, lauryl mercaptan, stearyl mercaptan and cyclohexyl mercaptan.

Examples of polymerization initiators that may be used include conventional thermal polymerization initiators, including azo compounds such as AIBN (azobisisobutyronitrile), and peroxides such as t-butyl peroxybenzoate and t-butylperoxy-2-ethylhexanoate (Perbutyl O, manufactured by NOF Corporation). Alternatively, a photopolymerization initiator may be used in which irradiation with an active energy beam is used to generate radicals.

Petroleum-based solvents (such as aroma-free (AF) solvents) and the like can be used as the polymerization solvent used in a solution polymerization. This polymerization solvent is preferably one or more solvents selected from among those solvents (described hereinafter) that can be used, as is, for the non-aqueous solvent within the ink.

During the polymerization reaction, other typically employed polymerization inhibitors, polymerization accelerators and dispersants and the like may also be added to the reaction system.

Subsequently, urethane groups are introduced into the obtained copolymer (the backbone polymer) by reacting the functional group capable of reacting with an amino group with an amino alcohol and a polyvalent isocyanate compound. The amino group of the amino alcohol reacts with, and bonds to, the functional group capable of reacting with an amino group within the monomer (B). The isocyanate ester group (R¹N═C═O) of the polyvalent isocyanate compound then undergoes an addition reaction with the hydroxyl group of the amino alcohol in the manner illustrated below, thus yielding a urethane group (urethane bond) (a carbamate ester: R¹NHCOOR):

R¹N═C═O+R—OH→ROCONHR¹

wherein R— represents the amino alcohol portion bonded to the functional group of the backbone polymer.

In this manner, urethane groups that function as pigment adsorption groups are introduced into the backbone polymer, which lacks any such pigment adsorption groups. In other words, introducing regions containing high-polarity urethane groups (urethane bonds) that can adsorb the pigment forms the core portion (the solvent-insoluble portion) of the NAD microparticles that incorporate the pigment.

The urethane groups form side chains (branches or grafted chains) on the main chain (backbone) of the acrylic polymer. The grafted chains containing the urethane group may be polyurethanes comprising repeating urethane bonds.

Examples of the amino alcohol include monomethylethanolamine, diethanolamine and diisopropanolamine. Of these, dialkanolamines (secondary alkanolamines) represented by a general formula (HOR)₂NH (wherein R is a divalent hydrocarbon group) are preferred, as they provide two hydroxyl groups, enabling the number of urethane groups formed to be increased. A combination of a plurality of these amino alcohols may also be used.

From the viewpoint of introducing an appropriate amount of urethane groups, this amino alcohol is preferably reacted in an amount within a range from 0.05 to 1 molar equivalents, and more preferably 0.1 to 1 molar equivalents, relative to the amount of the functional group capable of reacting with an amino group within the monomer (B). When the amount of the amino alcohol is less than 1 molar equivalent, unreacted functional groups will remain in some of the monomer (B) units, but it is thought that these residual functional groups act as pigment adsorption groups.

Examples of the polyvalent isocyanate compound include aliphatic, alicyclic and aromatic compounds, such as 1,6-diisocyanatohexane, 1,3-bis(isocyanatomethyl)benzene, 1,3-bis(isocyanatomethyl)cyclohexane, and 1,5-naphthalene diisocyanate. A plurality of these compounds may also be used in combination.

In order to ensure that no unreacted raw materials or the like remain following introduction of the urethane groups via reaction of the polyvalent isocyanate compound with the hydroxyl groups, the polyvalent isocyanate compound is preferably reacted in an amount that is substantially equivalent (0.98 to 1.02 molar equivalents) to the amount of hydroxyl groups contained within the supplied raw material.

In this manner, urethane side chains (grafts) that are insoluble in the solvent are formed at the amino alcohol sites bonded to the monomer (B) units within the copolymer (backbone polymer) that is soluble in the solvent, and these urethane side chains form dispersion particle nuclei. The final result of this process is the formation of polymer particles (NAD microparticles) enveloped within a shell structure (the backbone polymer) that can undergo solvation within the solvent.

In the above reaction, a polyhydric alcohol is preferably also added, so that the polyhydric alcohol and the polyvalent isocyanate compound are reacted. By adding a polyvalent alcohol, the urethane group formation can be repeated, enabling polyurethane side chains that function as higher polarity side chains (namely, branched polymers) to be obtained.

Examples of the polyhydric alcohol include ethylene glycol, propylene glycol, dipropylene glycol, 1,3-propanediol, polyethylene glycol and polypropylene glycol. A plurality of these polyhydric alcohols may also be used.

The polyhydric alcohol is important for controlling the size of the NAD particles, and as the amount of the polyhydric alcohol is increased, the NAD particles increase in size. However, if the particle size increases excessively, then the discharge stability and pigment dispersibility of the ink tend to deteriorate, and therefore the amount of the polyhydric alcohol relative to the amino alcohol is preferably within a range from 0 to 20 molar equivalents, and more preferably from 1 to 10 molar equivalents.

The mass ratio between the copolymer portion (backbone polymer) and the introduced urethane group portions (branches or branched polymers) within the graft copolymer is preferably within a range from 60:40 to 99:1, and is more preferably from 70:30 to 99:1. The mass of the copolymer portion represents the combined mass of the monomers used in the copolymerization, whereas the mass of the introduced urethane group portions represents the mass of the amino alcohol and polyvalent isocyanate compound used in the grafting reaction, or in those cases where a polyhydric alcohol is used, represents the combined mass of the amino alcohol, the polyvalent isocyanate compound and the polyhydric alcohol.

Although there are no particular restrictions on the molecular weight (mass average molecular weight) of the graft copolymer, in those cases where the copolymer is used in an inkjet ink, from the viewpoint of the ink discharge properties, the molecular weight is preferably within a range from approximately 10,000 to 100,000, and is more preferably from approximately 20,000 to 80,000.

The glass transition temperature (Tg) of the acrylic polymer of the graft copolymer is preferably equal to or lower than room temperature, and is more preferably 0° C. or lower. This ensures that when the ink is fixed on the recording medium, film formation is promoted at room temperature.

There are no particular restrictions on the particle size of the NAD microparticles, but when used within an inkjet ink, the particle size of the NAD microparticles must be sufficiently small compared with the nozzle diameter, and is typically not more than 0.3 μm, and preferably not more than 0.1 μm.

Examples of pigments that can be used for a black ink include carbon blacks such as furnace black, lamp black, acetylene black and channel black; metals or metal oxides such as copper, iron and titanium oxide; and organic pigments such as orthonitroaniline black. These pigments may be used either individually, or in combinations of two or more different pigments.

Examples of pigments that can be used for color inks include toluidine red, permanent carmine FB, disazo orange PMP, lake red C, brilliant carmine 6B, quinacridone red, dioxane violet, orthonitroaniline orange, dinitroaniline orange, vulcan orange, chlorinated para red, brilliant fast scarlet, naphthol red 23, pyrazolone red, barium red 2B, calcium red 2B, strontium red 2B, manganese red 2B, barium lithol red, pigment scarlet 3B lake, lake bordeaux 10B, anthocyn 3B lake, anthocyn 5B lake, rhodamine 6G lake, eosine lake, iron oxide red, naphthol red FGR, rhodamine B lake, methyl violet lake, dioxazine violet, naphthol carmine FB, naphthol red M, fast yellow AAA, fast yellow 10G disazo yellow AAMX, disazo yellow AAOT, disazo yellow AAOA, disazo yellow HR, isoindoline yellow, fast yellow G, disazo yellow AAA, phthalocyanine blue, Victoria pure blue, basic blue 5B lake, basic blue 6G lake, fast sky blue, alkali blue R toner, peacock blue lake, Prussian blue, ultramarine, reflex blue 2G; reflex blue R, alkali blue G toner, brilliant green lake, diamond green thioflavine lake, phthalocyanine green G, green gold, phthalocyanine green Y, iron oxide powder, rust powder, zinc white, titanium oxide, calcium carbonate, clay, barium sulfate, alumina white, aluminum powder, bronze powder, daylight fluorescent pigments, and pearl pigments. These pigments may be used either individually, or in arbitrary mixtures.

From the viewpoints of discharge stability and storage stability, the average particle size of the pigment is preferably not more than 300 nm, is more preferably not more than 150 nm, and is most preferably 100 nm or less. In this description, the average particle size of the pigment refers to the value measured using a dynamic light-scattering particle size distribution measurement apparatus LB-500 manufactured by Horiba, Ltd.

The term “non-aqueous solvent” refers to non-polar organic solvents and polar organic solvents for which the 50% distillation point is at least 150° C. The “50% distillation point” is measured in accordance with JIS K0066 “Test Methods for Distillation of Chemical Products” and refers to the temperature at which 50% by mass of the solvent is evaporated. From the viewpoint of safety, the use of a solvent for which this 50% distillation point is at least 160° C., and particularly 230° C. or higher, is preferred.

For example, examples of preferred non-polar organic solvents include aliphatic hydrocarbon solvents, alicyclic hydrocarbon solvents and aromatic hydrocarbon solvents. Specific examples of preferred aliphatic hydrocarbon solvents and alicyclic hydrocarbon solvents include Teclean N-16, Teclean N-20, Teclean N-22, Nisseki Naphtesol L, Nisseki Naphtesol M, Nisseki Naphtesol H, No. 0 Solvent L, No. 0 Solvent M, No. 0 Solvent H, Nisseki Isosol 300, Nisseki Isosol 400, AF-4, AF-5, AF-6 and AF-7, all manufactured by Nippon Oil Corporation; and Isopar G, Isopar H, Isopar L, Isopar M, Exxsol D40, Exxsol D80, Exxsol D100, Exxsol D130 and Exxsol D140, all manufactured by Exxon Mobil Corporation. Specific examples of preferred aromatic hydrocarbon solvents include Nisseki Cleansol G (alkylbenzene) manufactured by Nippon Oil Corporation, and Solvesso 200 manufactured by Exxon Mobil Corporation.

Examples of solvents that can be used as the polar organic solvent include ester-based solvents, alcohol-based solvents, higher fatty acid-based solvents, ether-based solvents, and mixtures thereof. Specific examples include:

ester-based solvents containing 14 or more carbon atoms within each molecule, such as methyl laurate, isopropyl laurate, isopropyl myristate, isopropyl palmitate, isostearyl palmitate, methyl oleate, ethyl oleate, isopropyl oleate, butyl oleate, methyl linoleate, isobutyl linoleate, ethyl linoleate, isopropyl isostearate, methyl soybean oil, isobutyl soybean oil, methyl tallate, isobutyl tallate, diisopropyl adipate, diisopropyl sebacate, diethyl sebacate, propylene glycol monocaprate, trimethylolpropane tri-2-ethylhexanoate and glyceryl tri-2-ethylhexanoate;

alcohol-based solvents containing 12 or more carbon atoms within each molecule, such as isomyristyl alcohol, isopalmityl alcohol, isostearyl alcohol and oleyl alcohol;

higher fatty acid-based solvents such as isononanoic acid, isomyristic acid, hexadecanoic acid, isopalmitic acid, oleic acid and isostearic acid; and

ether-based solvents such as diethylene glycol monobutyl ether, ethylene glycol monobutyl ether, propylene glycol monobutyl ether and propylene glycol dibutyl ether.

These non-aqueous solvents may be used either individually, or in mixtures of two or more different solvents.

The ink may also include other arbitrary components in amounts that do not impair the effects of the present invention.

For example, compounds or resins that may be added besides the above NAD microparticles include acrylic resins, styrene-acrylic resins, styrene-maleic acid resins, rosin-based resins, rosin ester-based resins, ethylene-vinyl acetate resins, petroleum resins, coumarone-indene resins, terpene phenol resins, phenolic resins, urethane resins, melamine resins, urea resins, epoxy resins, cellulose-based resins, vinyl chloride acetate resins, xylene resins, alkyd resins, aliphatic hydrocarbon resins, butyral resins, maleic acid resins, fumaric acid resins, hydroxyl group-containing carboxylate esters, salts of long-chain polyaminoamides and high-molecular weight acid esters, salts of high-molecular weight polycarboxylic acids, salts of long-chain polyaminoamides and polar acid esters, high-molecular weight unsaturated acid esters, high-molecular weight copolymers, modified polyurethanes, modified polyacrylates, polyether ester anionic surfactants, naphthalenesulfonic acid-formalin condensate salts, aromatic sulfonic acid-formalin condensate salts, polyoxyethylene alkyl phosphate esters, polyoxyethylene nonyl phenyl ethers, polyester polyamines, and stearyl amine acetate.

Suitable amounts of nozzle blockage prevention agents, antioxidants, conductivity modifiers, viscosity modifiers, surface tension modifiers and oxygen absorbers and the like may also be added. There are no particular restrictions on the nature of these additives, and the types of materials typically used within this technical field may be used.

The amount of the pigment within the ink is typically within a range from 0.01 to 20% by mass, and from the viewpoints of print density and ink viscosity, is preferably within a range from 1 to 15% by mass, and more preferably from 5 to 10% by mass.

In terms of ensuring favorable pigment dispersibility, the amount of the NAD microparticles within the ink is preferably not less than 0.1% by mass, and is more preferably 2% by mass or more. In contrast, if the amount of the NAD microparticles is too high, then not only does the ink viscosity become overly high, but the storage stability under high-temperature conditions also tends to worsen, and therefore the amount of the NAD microparticles is preferably not more than 20% by mass, and is more preferably 10% by mass or less. The amount of the NAD microparticles within the ink is most preferably within a range from 3 to 8% by mass.

The mass of the NAD microparticles (or the total mass of resin in those cases where the ink includes other resins besides the NAD microparticles) per 1 unit of mass of the pigment is preferably at least 0.5 from the viewpoint of ensuring a favorable pigment dispersibility effect, and is preferably not more than 1 from the viewpoints of improving the ink viscosity and avoiding discharge faults caused by changes in the ink over time.

When used within an inkjet recording system, the ideal range for the viscosity of the ink varies depending on factors such as the diameter of the discharge head nozzles and the discharge environment, but at 23° C., is typically within a range from 5 to 30 mPa·s, and preferably from 5 to 15 mPa·s, and is most preferably approximately 10 mPa·s for use within an inkjet recording apparatus. Here, the viscosity is measured at 23° C. by raising the shear stress from 0 Pa at a rate of 0.1 Pa/s, and refers to the measured value at 10 Pa.

Next is a description of the treatment liquid used in combination with the above ink.

The treatment liquid comprises a compound (R) capable of reacting with the β-diketone group or β-keto ester group of the monomer (C) units within the copolymer. Specifically, a compound containing at least one functional group selected from the group consisting of primary and secondary amino groups, an isocyanate group, an aldehyde group, a vinyl group and (meth)acryloyl groups, or a compound containing a polyvalent metal ion can be used favorably. The term “polyvalent metal ion” describes a metal ion that is capable of forming a chelate linkage with the β-diketone group or β-keto ester group (namely, a chelate ring-formable metal ion).

More specific examples of the compound (R) are listed below. For example, representative examples of amino group-containing compounds include polyamides having an active hydrogen equivalent weight of 50 to 300, ethylenediamine, trimethylenediamine, hexamethylenediamine, diethylenetriamine, triethylenetetramine, tetraethylenepentamine, diethylaminopropylamine, polyamide-polyamines and menthanediamine. Representative examples of isocyanate group-containing compounds include tolylene diisocyanate, 1,4-diphenylmethane diisocyanate, 1,5-naphthalene diisocyanate, triphenylmethane triisocyanate, tolidine diisocyanate, xylene diisocyanate, dicyclohexylmethane diisocyanate, and hexamethylene diisocyanate. Representative examples of aldehyde group-containing compounds include dodecyl aldehyde, nonyl aldehyde, and heptyl aldehyde. Representative examples of vinyl group-containing compounds include divinylbenzene and N-vinylformamide. Representative examples of (meth)acryloyl group-containing compounds include 1,6-hexanediol (meth)acrylate and 1,9-nonanediol (meth)acrylate. Representative examples of polyvalent metal ion-containing compounds include metal soaps and chelate compounds and the like containing Al, Zn or Zr or the like.

Any of the above compounds may be used individually, or a combination of a plurality of compounds may be used.

The treatment liquid is preferably prepared by dissolving the above compound (R) in the same non-aqueous solvent as that used in the ink described above.

From the viewpoint of ensuring satisfactory reactivity with the β-diketone group or β-keto ester group, the compound (R) is preferably included in the treatment liquid in an amount of not less than 1% by mass. However, depending on the solubility of the compound (R) within the non-aqueous solvent used in the treatment liquid, the compound (R) may sometimes precipitate during storage of the treatment liquid, causing a dramatic variation in the viscosity. This tends to cause a deterioration in the print quality, and therefore the amount of the compound (R) within the treatment liquid is preferably not more than 30% by mass, and is more preferably within a range from 3 to 20% by mass. In the case of a compound that contains a polyvalent metal ion, the preferred amount for the amount of the compound is expressed in terms of the metal content.

The treatment liquid may be a colored liquid comprising an arbitrary colorant. There are no particular restrictions on the type or color of the colorant used, and for example, a cyan-based colorant may be included. In such a case, by using a black pigment for the pigment within the aforementioned ink, and then using this ink to overprint the treatment liquid containing the cyan-based colorant, a higher density black can be achieved.

Specific examples of the cyan-based colorant include ultramarine blue, Prussian blue, cobalt blue and phthalocyanine-based pigments.

The treatment liquid may also include other components, provided their inclusion does not impair the effects of the present invention. Further, depending on the nature of the functional groups included within the compound (R), if required, a catalyst may also be added to enhance the reactivity with the β-diketone group or β-keto ester group.

A printing method according to the present invention uses the ink set described above, and comprises: adhering the treatment liquid described above to a recording medium, and using the ink described above to form an image on the recording medium having the treatment liquid adhered thereto. Because the treatment liquid is applied first to the recording medium, the ink droplets of the subsequently applied ink can be aggregated at the surface of the recording medium. Accordingly, the pigment within the ink is harder to penetrate into the interior of the printed paper, and is more readily retained at the paper surface, meaning the resulting printed item has a higher print density.

All manner of paper types can be used as the recording medium, and plain papers such as copier paper and recycled copier paper are preferred. Coated paper that has been subjected to a surface treatment can also be used.

There are no particular restrictions on the method used for adhering the treatment liquid to the recording medium, and for example, the treatment liquid may be adhered using an inkjet recording apparatus in a similar manner to the ink, or may be applied by using a roller or sprayer to apply the required amount of the treatment liquid. The treatment liquid may be either applied to the entire surface of the paper, or applied selectively to only those locations where an image is to be formed. Alternatively, the treatment liquid may be applied only to those locations where the amount of ink to be applied exceeds a specified value per unit of surface area, such as areas of solid printing.

The applied amount of the treatment liquid, reported as a weight per unit of surface area, is preferably within a range from 0.05 to 1 times the weight of ink applied, and is more preferably from 0.1 to 0.6 times the weight of ink applied.

A drying step need not necessarily be provided following application of the treatment liquid, and image formation may be conducted immediately thereafter, although if necessary, a heated drying step may be provided to enhance the reactivity between the treatment liquid and the ink.

Although there are no particular restrictions on the printing method that uses the ink, conducting printing using an inkjet recording apparatus is preferred. The inkjet printer may employ any of various printing systems, including a piezo system, electrostatic system or thermal system. In those cases where an inkjet recording apparatus is used, the ink is discharged from the inkjet head based on a digital signal, and the discharged ink droplets are adhered to the recording medium.

### EXAMPLES

The present invention is described in further detail below based on a series of examples, but the present invention is in no way limited by these examples. In the following description, the units “% by mass” are abbreviated as “%”.

### Example 1

### (1) Synthesis of Copolymers (Backbone Polymers a and b)

A 300 ml four-neck flask was charged with 75 g of AF-4 (a naphthene-based solvent, manufactured by Nippon Oil Corporation), and the temperature was raised to 110° C. under a stream of nitrogen gas and with constant stirring. Subsequently, with the temperature held at 110° C., a mixture containing a monomer mixture with the composition shown in Table 1, 16.7 g of AF-4 and 2 g of Perbutyl O (t-butylperoxy-2-ethylhexanoate, manufactured by NOF Corporation) was added dropwise to the flask over a period of 3 hours. Subsequently, with the temperature maintained at 110° C., additional 0.2 g samples of Perbutyl O were added after stirring for an additional one hour and two hours respectively. The reaction mixture was aged for a further one hour at 110° C., and was then diluted with 10.6 g of AF-4, yielding a colorless and transparent solution of a backbone polymer a or b with a non-volatile fraction of 50%.

The mass average molecular weight (determined by a GPC method and referenced against polystyrene standards) of each of the obtained backbone polymers was within a range from 20,000 to 23,000.

TABLE 1
Backbone polymer composition

| | | Backbone | Backbone |
|---|---|---|---|
| Monomer (g) | | polymer a | polymer b |
| VMA (monomer A) | Behenyl methacrylate | 50 | 50 |
| EHMA (monomer D) | 2-ethylhexyl | 15 | 35 |
| | methacrylate | | |
| GMA (monomer B) | Glycidyl methacrylate | 15 | 15 |
| AAEM (monomer C) | 2-acetoacetoxyethyl | 20 | 0 |
| | methacrylate | | |

Details of the monomers used are as listed below.

Monomer (A): VMA (number of carbon atoms within the alkyl group: 22): behenyl methacrylate (manufactured by NOF Corporation)

Monomer (B): GMA: glycidyl methacrylate

Monomer (C): AAEM: 2-acetoacetoxyethyl methacrylate (manufactured by Nippon Synthetic Chemistry Industry Co., Ltd.)

Monomer (D): EHMA: (number of carbon atoms within the alkyl group: 8): 2-ethylhexyl methacrylate

Unless stated otherwise, all reagents were manufactured by Wako Pure Chemical Industries, Ltd. (this also applies in the following description).

### (2) Production of Non-Aqueous Dispersion Containing NAD Microparticles

A 500 mL four-neck flask was charged with 81 g of isooctyl palmitate (IOP, manufactured by Nikko Chemicals Co., Ltd.), 200 g of the solution of the backbone polymer a obtained in (1) above (solid fraction within AF-4 solvent: 50%), 4.0 g of propylene glycol and 2.8 g of diethanolamine, and the temperature was raised to 110° C. under a stream of nitrogen gas and with constant stirring. The temperature was held at 110° C. for one hour to enable the reaction between the glycidyl groups of the backbone polymer a and the diethanolamine to proceed to completion. Subsequently, 0.2 g of dibutyltin dilaurate was added, and a mixture containing 10.2 g of Takenate 600 (1,3-bis(isocyanatomethyl)cyclohexane, manufactured by Mitsui Chemicals, Inc.) and 91.8 g of IOP was then added dropwise to the flask over a period of one hour. Following completion of the dropwise addition, the temperature was raised to 120° C., the reaction was allowed to proceed for 6 hours, and the reaction mixture was then cooled, yielding a non-aqueous dispersion D1 (AF-4: 25.7%, IOP: 44.3%) having a solid fraction (NAD microparticles) of 30%.

Using the same method, a non-aqueous dispersion D2 was produced with the composition shown in Table 2. The amounts listed for the backbone polymers in Table 2 represent solid fraction amounts.

The mass average molecular weight (determined by a GPC method and referenced against polystyrene standards) for each of the obtained graft copolymers (including the branch polymers) was within a range from 22,000 to 26,000, and the mass ratio between the backbone polymer and the branch polymers was 85:15.

TABLE 2
Composition of non-aqueous dispersions

| (Blend amount/g) | | D1 | D2 |
|---|---|---|---|
| Backbone polymer | Backbone polymer a | 100.0 | 0.0 |
| | Backbone polymer b | 0.0 | 100.0 |
| Branch polymer | Propylene glycol | 4.0 | 4.0 |
| | Diethanolamine | 2.8 | 2.8 |
| | Diisocyanate | 10.2 | 10.2 |
| Solvent | AF-4 | 150.0 | 150.0 |
| | IOP | 201.0 | 201.0 |

| | | |
|---|---|---|
| Total | 468 | 468.0 |

### (3) Preparation of Inks

10 g of the prepared dispersion D1, 5.0 g of a pigment (carbon black MA11, manufactured by Mitsui Chemicals, Inc.), 5.0 g of AF-4 and 5.0 g of IOP were mixed, zirconia beads (diameter: 0.5 mm) were added, and the mixture was dispersed for 120 minutes using a rocking mill (manufactured by Seiwa Technical Lab Co., Ltd.). Following dispersion, the zirconia beads were removed, the dispersion was filtered sequentially through 3.0 μm and 0.8 μm membrane filters to remove any contaminants and coarse particles, and the mixture was diluted with 12.5 g of AF-4 and 12.5 g of IOP to form a total mass of 50 g, thus completing preparation of an ink 1 in which the pigment is dispersed by the NAD microparticles (pigment content: 10%).

Using the blend amounts shown in Table 3, an ink 2 and an ink 3 were prepared in the same manner as the ink 1.

In the ink 3, Solsperse 28000 (S28000, manufactured by The Lubrizol Corporation, solid fraction: 100%) was used instead of the non-aqueous dispersion.

All of the prepared inks exhibited viscosity and pigment size properties that were appropriate for use as inkjet inks.

TABLE 3
Ink composition

| (Blend amount/g) | | Ink 1 | Ink 2 | Ink 3 |
|---|---|---|---|---|
| Pigment | | 5 | 5 | 5 |
| Non-aqueous dispersion | D1 | 10 | | |
| | D2 | | 10 | |
| Solsperse 28000 | | | | 2.5 |
| Diluent during dispersion | AF-4 | 5 | 5 | 8.75 |
| | IOP | 5 | 5 | 8.75 |
| Viscosity modifying | AF-4 | 12.5 | 12.5 | 12.5 |
| solvent | IOP | 12.5 | 12.5 | 12.5 |

| | | | |
|---|---|---|---|
| Total | 50 | 50 | 50 |

### (4) Preparation of Treatment Liquids

Using the blend amounts shown in Table 4, treatment liquids 1 to 4, each having an active component fraction of 10%, and a treatment liquid 5 containing no active component were prepared. The Zinc hexoate is a mineral spirit solution with a solid fraction of 65% (metal content: 15%), manufactured by Toei Chemical Industry Co., Ltd.

TABLE 4
Treatment liquid composition

| | | Treatment | Treatment | Treatment | Treatment | Treatment |
|---|---|---|---|---|---|---|
| (Blend amount/g) | | liquid 1 | liquid 2 | liquid 3 | liquid 4 | liquid 5 |
| Compound (R) | Stearylamine | 5 | | | | |
| | Zinc hexoate(see note) | | 33.33 | | | |
| | Dodecyl aldehyde | | | 5 | | |
| | Solsperse 28000 | | | | 5 | |
| Diluent during dispersion | AF-4 | 22.5 | 8.33 | 22.5 | 22.5 | 25 |
| | IOP | 22.5 | 8.33 | 22.5 | 22.5 | 25 |

| | | | | | |
|---|---|---|---|---|---|
| Total | 50 | 50 | 50 | 50 | 50 |

Note:
metal content: 15%

Based on the combinations shown in Table 5, each of the treatment liquids was used to fill a colored ink bottle (for example, one of cyan, magenta and yellow) of an inkjet printer HC5500 (manufactured by Riso Kagaku Corporation), while the ink 1 or ink 2 was used to fill the black ink bottle. The thus refilled ink bottles were installed in the HC5500 printer, and using the treatment liquid as a first liquid and the ink 1 or ink 2 as a second liquid, inkjet printing was conducted by printing the first liquid and the second liquid sequentially onto plain paper (Riso lightweight paper, manufactured by Riso Kagaku Corporation). The HC5500 is a system that uses a 300 dpi line-type inkjet head (in which the nozzles are aligned with an approximately 85 μm spacing therebetween), wherein the paper is transported in a sub-scanning direction perpendicular to the main scanning direction (the direction along which the nozzles are aligned) while printing is conducted.

### <Density of Printed Items>

The OD values for the printed surface and the rear surface of each solid printed image were measured using an optical densitometer (RD920, manufactured by Macbeth Corporation), and were then evaluated against the criteria listed below. A high OD value for the printed surface indicates a high image density, and a low OD value for the rear surface indicates minimal show-through, both of which are desirable.

Print Density (Surface OD Value)
A: 1.40 or greater, B: 1.31 to 1.39, C, 1.21 to 1.30, D: 1.20 or lower

Print Density (Rear Surface OD Value)
A: 0.30 or lower, B: 0.31 to 0.35, C, 0.36 to 0.40, D: 0.41 or greater

The results of the above evaluations are summarized in Table 5.

TABLE 5
Ink sets and evaluations thereof

| | | | | Compara- | Compara- | Compara- | Compara- | Compara- | Compara- | Compara- | Compara- |
|---|---|---|---|---|---|---|---|---|---|---|---|
| | | | | tive | tive | tive | tive | tive | tive | tive | tive |
| | Example 1 | Example 2 | Example 3 | example 1 | example 2 | example 3 | example 4 | example 5 | example 6 | example 7 | example 8 |
| | Treatment liquid | | | | | | | | | | |
| | Treatment | Treatment | Treatment | Treatment | Treatment | Treatment | Treatment | Treatment | Treatment | Treatment | Treatment |
| | liquid 1 | liquid 2 | liquid 3 | liquid 4 | liquid 5 | liquid 1 | liquid 2 | liquid 4 | liquid 1 | liquid 2 | liquid 4 |
| | Ink | | | | | | | | | | |
| | Ink 1 | Ink 1 | Ink 1 | Ink 1 | Ink 1 | Ink 2 | Ink 2 | Ink 2 | Ink 3 | Ink 3 | Ink 3 |
| Print density | A | A | B | B | B | B | B | C | B | C | D |
| (surface OD) | | | | | | | | | | | |
| Print density | A | A | B | C | C | B | B | C | D | D | D |
| (rear surface OD) | | | | | | | | | | | |

The combinations of the treatment liquids 1 to 3 containing the compound (R) with the ink 1 containing the graft copolymer comprising the backbone polymer a as a pigment dispersant represent ink sets of examples of the present invention, and as is evident from Table 5, each of the ink sets of these examples exhibited high density and minimal show-through for the printed item.

In contrast, as is evident from the results for comparative examples 1 and 2, when a treatment liquid containing none of the compound (R) was used, satisfactory print density was unattainable, and significant show-through was also observed. Further, as is evident from the results of comparative examples 3 to 5, in the case of the ink 2 that uses a graft copolymer comprising the backbone polymer b that contains no monomer (C) as the pigment dispersant, satisfactory print density was unattainable and image show-through was observed even when the ink was combined with a treatment liquid containing the compound (R). Moreover, as is evident from comparative examples 6 to 8, the results for the ink 3 comprising a commercially available pigment dispersant were even more unsatisfactory.

What is claimed is:

1. An ink set, comprising:
a non-aqueous pigment ink comprising a pigment, a non-aqueous solvent, and a non-aqueous resin dispersion microparticle having a pigment dispersion capability, wherein
the non-aqueous resin dispersion microparticle is a graft copolymer prepared by introducing urethane groups into a copolymer formed from a monomer mixture comprising an alkyl(meth)acrylate (A) having an alkyl group of 12 or more carbon atoms, a reactive (meth)acrylate (B) having a functional group capable of reacting with an amino group, and a (meth)acrylate (C) having a β-diketone group or β-keto ester group by reacting the functional group capable of reacting with an amino group with an amino alcohol and a polyvalent isocyanate compound, and
a treatment liquid comprising a compound capable of reacting with the β-diketone group or β-keto ester group.

2. The ink set according to claim 1, wherein in the graft copolymer, the functional group capable of reacting with an amino group is at least one functional group selected from the group consisting of a glycidyl group, vinyl group and (meth)acryloyl group.

3. The ink set according to claim 1, wherein the compound within the treatment liquid that is capable of reacting with the β-diketone group or β-keto ester group is either a compound comprising at least one functional group selected from the group consisting of primary and secondary amino groups, an isocyanate group, an aldehyde group, a vinyl group and (meth)acryloyl groups, or a compound comprising a polyvalent metal ion.

4. The ink set according to claim 1, wherein the monomer mixture used in forming the graft copolymer comprises 1 to 30% by mass of the reactive (meth)acrylate (B).

5. The ink set according to claim 1, wherein the monomer mixture used in forming the graft copolymer comprises 3 to 30% by mass of the (meth)acrylate (C) having a β-diketone group or β-keto ester group.

6. The ink set according to claim 1, wherein the treatment liquid further comprises a cyan-based colorant.

7. A printing method, comprising:
adhering a treatment liquid comprising a compound capable of reacting with a β-diketone group or β-keto ester group to a recording medium, and
forming an image on the recording medium using a non-aqueous pigment ink comprising a pigment, a non-aqueous solvent, and a non-aqueous resin dispersion microparticle having a pigment dispersion capability, wherein
the non-aqueous resin dispersion microparticle is a graft copolymer prepared by introducing urethane groups into a copolymer formed from a monomer mixture comprising an alkyl(meth)acrylate (A) having an alkyl group of 12 or more carbon atoms, a reactive (meth)acrylate (B) having a functional group capable of reacting with an amino group, and a (meth)acrylate (C) having a β-diketone group or β-keto ester group by reacting the functional group capable of reacting with an amino group with an amino alcohol and a polyvalent isocyanate compound.
